(19) United States
(12) Patent Application Publication
(10) Pub. No.: US 2025/0052595 A1
(43) Pub. Date: Feb. 13, 2025

(54) SENSOR DEVICE WITH A SENSOR ELEMENT, A PROCESSING UNIT AND A COMMUNICATION INTERFACE, AND A METHOD FOR OPERATING A SENSOR DEVICE

(71) Applicant: Robert Bosch GmbH, Stuttgart (DE)

(72) Inventors: David Slogsnat, Tuebingen (DE); Martin Kittel, Stuttgart (DE)

(21) Appl. No.: 18/779,138

(22) Filed: Jul. 22, 2024

(30) Foreign Application Priority Data
Aug. 7, 2023 (DE) 10 2023 207 542.3

(51) Int. Cl. G01D 3/036

(52) U.S. Cl. CPC G01D 3/036

(57) ABSTRACT

A sensor device. The sensor device includes a sensor element, a processing unit, and a communication interface. The processing unit is configured to receive a desired sampling frequency and a desired measurement duration via the communication interface, and to determine a necessary distance in time between two consecutive measurements depending on the desired sampling frequency and the desired measurement duration, and to sample a measurement signal of the sensor element depending on the necessary distance in time between two consecutive measurements. A method for operating a sensor device is also described.

### CROSS REFERENCE

The present application claims the benefit under 35 U.S.C. § 119 of German Patent Application No. 10 2023 207 542.3 filed on Aug. 7, 2023, which is expressly incorporated herein by reference in its entirety.

### BACKGROUND INFORMATION

A sensor device measures physical quantities, such as acceleration, pressure, or temperature, by sampling a corresponding measurement signal of a sensor element of the sensor device.

Typically, in such a sensor device, the sampling frequency can be configured by making a selection from specified sampling frequencies implemented as a lookup table, for example. The user selects the required sampling frequency from the available ones. If the exact sampling frequency is not available, the next higher one is usually selected. However, depending on the number of available sampling frequencies, the distance between two sampling frequencies may be large. Since the power consumption of the sensor device is typically dependent on the sampling frequency, a large deviation of the required and set sampling frequency is associated with an undesirable increased energy demand.

A non-ideally matching sampling frequency may also have a negative effect on the further processing of the sensor data, if they are to be combined with the data of another sensor device that samples at a different frequency. If the sampling frequency of the sensor device and the retrieval frequency of the user do not match, aliasing may also occur.

The aforementioned problems in the related art may be solved by features of the present invention.

### SUMMARY

The present invention relates to a sensor device with a sensor element, a processing unit, and a communication interface, wherein the processing unit is configured to receive a desired sampling frequency and a desired measurement duration via the communication interface, and to determine a necessary distance in time between two consecutive measurements depending on the desired sampling frequency and the desired measurement duration, and to sample a measurement signal of the sensor element depending on the necessary distance in time between two consecutive measurements.

Advantageously, this makes free selection of the sampling frequency possible. This makes it possible to use precisely the frequency required by the application or desired by the user. On the one hand, this has the advantage that the sensor device and other sensor devices can be operated at the same frequency, which makes further processing of the data significantly easier. In addition, the energy demand is optimized since the sensor device does not need to record more sensor data than necessary.

For example, the sensor device can comprise a sensor element designed as a MEMS component. However, the sensor element may also be another type of component.

For example, the sensor element may be designed as an acceleration sensor, pressure sensor, or temperature sensor and may accordingly output an acceleration signal, pressure signal, or temperature signal as a measurement signal. This measurement signal may accordingly be sampled by the processing unit, wherein sampling is understood to mean sensing measured values over a respective measurement at discrete, usually equidistant time points. In particular, an AD converter can be used in the sampling of the measurement signal, for example.

For example, the processing unit may be designed as a computing unit, in particular as a microcontroller.

According to an example embodiment of the present invention, the communication interface may be designed such that data reception is possible from a unit external to the sensor device. This data reception may be wired. However, additionally or alternatively, the data reception may also function wirelessly. An external unit may, for example, represent a control device, which may be operable accordingly by a user of the sensor device in order to transmit the desired sampling frequency and desired measurement duration to the sensor device, or a further sensor device. Additionally, the processing unit may also be configured to transmit the sampled measurement signal by means of the communication interface to the user or to another external unit.

The sampling frequency is understood to mean the frequency at which a measurement signal is sampled per time interval. The desired sampling frequency is specifiable externally and is typically specified in Hz.

The measurement duration is understood to mean the time period that a measurement process lasts per sampling.

The time period between the end of a measurement and the start of the subsequent measurement is understood to mean a necessary distance in time which takes into account the desired sampling frequency and desired measurement duration. The distance in time may be specified in cycles of a clock signal.

One example embodiment of the present invention provides that the processing unit is configured to determine the necessary distance in time between two consecutive measurements as the difference between the reciprocal value of the desired sampling frequency and the desired measurement duration.

Advantageously, this is a simple possibility of determining the necessary distance in time between two consecutive measurements. The corresponding determination is resource-efficient and quickly implementable.

The reciprocal value of the sampling frequency is understood to mean the period duration of the sampling, which in turn is understood to mean the time period between the end of a measurement and the end of the subsequent measurement. The period duration thus represents the time period required between the results of consecutive measurements in order to satisfy the desired sampling frequency. Ideally, period duration and measurement duration are specified in the number of pulses of the clock signal.

Since the period duration is in a fixed relationship with the desired sampling frequency, the period duration does not necessarily have to be calculated but may, for example, also be kept in a table in a memory unit, wherein each possible value of the sampling frequency is assigned the associated value of the period duration in this lookup table and can thus be accessed directly without calculation. However, if the sensor device has a sufficiently powerful processing unit, the implementation as a calculation is advantageous since it requires significantly less silicon surface area in the technical implementation than a corresponding lookup table.

In particular, the necessary distance in time between two consecutive measurements at a constant measurement duration may also be determined by means of a lookup table. However, alternatively, a calculation is again possible and correspondingly advantageous with a view to the silicon surface area required for the technical implementation.

One example embodiment of the present invention provides that the sensor device comprises a memory unit, wherein the processing unit is configured to store the desired sampling frequency, received by means of the communication interface, and/or the desired measurement duration, received by means of the communication interface, in the memory unit and to read them/it from the memory unit.

Advantageously, the information received via the communication interface can be stored and, as needed, used at any later time. This makes simple, secure, and quick handling of the corresponding information possible.

The memory unit may be integrated in the processing unit or designed as a separate component. For example, the memory unit may have a memory area of n bits, into which the desired sampling frequency may be written by means of the processing unit, where n is a natural number. For example, the sampling frequency may be a number in the range of 1 to 2\hat{ }n Hz, again with n as a natural number. Likewise, the sampling frequency may be a rational number represented by a fixed-point number in the memory area. For example, in the case of 4 decimal places, a sampling frequency in the range 2\hat{ }-4 to 2\hat{ }(n−4] Hz can be represented. Alternatively, the memory area can also be switchable so that a selection can be made between a plurality of formats and a large range of sampling frequencies can thus be covered with a small number of bits n.

The present invention also relates to a method for operating a sensor device, in particular a sensor device according to one of the above-described embodiments. According to an example embodiment of the present invention, the method comprises the following method steps:
a. receiving a desired sampling frequency via a communication interface of the sensor device,
b. receiving a desired measurement duration via the communication interface,
c. determining a necessary distance in time between two consecutive measurements depending on the desired sampling frequency and the desired measurement duration,
d. sampling a measurement signal of a sensor element of the sensor device depending on the necessary distance in time between two consecutive measurements.

Advantageously, this makes free selection of the sampling frequency possible. This makes it possible to use precisely the frequency required by the application. On the one hand, this has the advantage that all sensors can be operated at the same frequency in order to make further processing of the data significantly easier. In addition, the energy demand is optimized since the sensor does not need to record more data than necessary.

According to a further example embodiment of the present invention, it is provided that, in method step c, the necessary distance in time between two consecutive measurements is determined as the difference between the reciprocal value of the desired sampling frequency and the desired measurement duration.

Advantageously, this is a simple possibility of determining the necessary distance in time between two consecutive measurements. The corresponding determination is resource-efficient and quickly implementable.

According to a further example embodiment of the present invention, it is provided that, in method step a, the desired sampling frequency received by means of the communication interface and/or, in method step b, the desired measurement duration received by means of the communication interface is stored in a memory unit of the sensor device, and, in method step c, the desired sampling frequency and/or the desired measurement duration is read from the memory unit.

Advantageously, the information received via the communication interface can be stored and, as needed, used at any later time. This makes simple, secure, and quick handling of the corresponding information possible.

### BRIEF DESCRIPTION OF THE DRAWINGS

FIG. 1 shows an embodiment example of a sensor device according to an example embodiment of the present invention.

FIG. 2 shows a method according to an example embodiment of the present invention for operating a sensor device.

FIG. 3 shows a time curve of a sampling process of a measurement signal of a sensor element of a sensor device, according to an example embodiment of the present invention.

### DETAILED DESCRIPTION OF EXAMPLE EMBODIMENTS

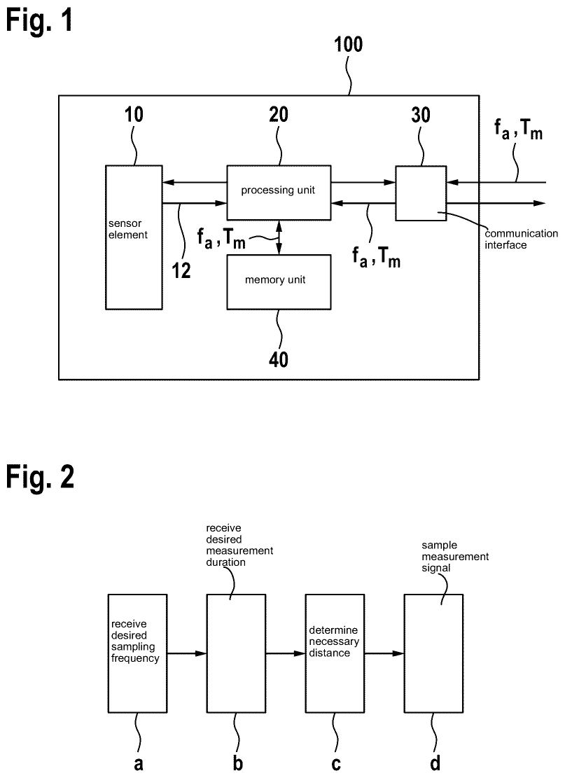

FIG. 1 shows an embodiment example of a sensor device according to the present invention in a schematic view.

A sensor device 100 is shown. The sensor device 100 comprises a sensor element 10, a processing unit 20, and a communication interface 30.

The processing unit 20 is configured to receive a desired sampling frequency fₐ and a desired measurement duration Tₘ via the communication interface 30.

Furthermore, the processing unit 20 is configured to determine a necessary distance in time ΔT between two consecutive measurements depending on the desired sampling frequency fₐ and the desired measurement duration Tₘ. The processing unit 20 may be configured to determine the necessary distance in time ΔT between two consecutive measurements as the difference between the reciprocal value of the desired sampling frequency fₐ and the desired measurement duration Tₘ.

The processing unit 20 is also configured to sample a measurement signal 12 of the sensor element 10 depending on the necessary distance in time ΔT between two consecutive measurements.

The sensor device 100 may also comprise a memory unit 40. In this case, the processing unit 20 may be configured to store the desired sampling frequency fₐ, received by means of the communication interface 30, and/or the desired measurement duration Tₘ, received by means of the communication interface 30, in the memory unit 40 and to read them/it from the memory unit 40.

Furthermore, the processing unit 20 may be configured to transmit the measurement results of the sampling of the measurement signal 12 by means of the communication interface 30.

FIG. 2 shows a method according to the present invention for operating a sensor device.

In a method step a, a desired sampling frequency fₐ is received via a communication interface 30 of the sensor device 100. Furthermore, in a method step b, a desired measurement duration Tₘ is received via the communication interface. The method steps a and b may take place in succession or in parallel as desired. Here, in method step a, the desired sampling frequency fₐ received by means of the communication interface 30 and/or, in method step b, the desired measurement duration Tₘ received by means of the communication interface can be stored in a memory unit 40 of the sensor device 100, and that, in method step c, the desired sampling frequency fₐ and/or the desired measurement duration Tₘ can be read from the memory unit 40.

Subsequently, in a method step c, a necessary distance in time ΔT between two consecutive measurements is determined depending on the desired sampling frequency fₐ and the desired measurement duration Tₘ, which were received in method step a and method step b, respectively. In method step c, the necessary distance in time ΔT between two consecutive measurements may be determined as the difference between the reciprocal value of the desired sampling frequency fₐ and the desired measurement duration Tₘ. In method step c, the desired sampling frequency fₐ and/or the desired measurement duration Tₘ may also be read from the memory unit 40.

Afterwards, in a method step d, a measurement signal 12 of a sensor element 10 of the sensor device 100 is sampled depending on the necessary distance in time ΔT, determined in method step c, between two consecutive measurements.

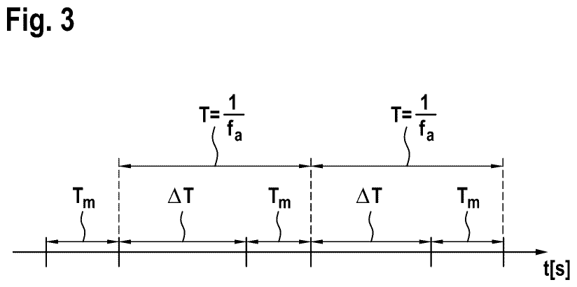

FIG. 3 shows a time curve of a sampling process of a measurement signal of a sensor element of a sensor device.

A sampling process over time in which the measurement signal 12 is sampled on three consecutive measurements is shown. Each of the measurements has a desired measurement duration Tₘ. The time period between the end of a measurement and the start of the subsequent measurement is referred to as the necessary distance in time ΔT. This necessary distance in time ΔT must accordingly be selected correctly so that the desired sampling frequency fₐ can be achieved while taking into account the desired measurement duration Tₘ. Furthermore, the time period between the end of a measurement and the end of the subsequent measurement is referred to as the period duration T, which represents the reciprocal value of the desired sampling frequency fₐ.

Consequently, the measurement signal 12 is sampled over the desired measurement duration Tₘ and measured accordingly. After the end of this measurement, waiting takes place for the necessary distance in time ΔT, and the next measurement or sampling of the measurement signal 12 with the desired measurement duration Tₘ is started then. This process is then continued accordingly. The desired sampling frequency f can thereby be achieved.

What is claimed is:

1. A sensor device, comprising:
a sensor element;
a processing unit; and
a communication interface;
wherein the processing unit is configured to:
receive a desired sampling frequency and a desired measurement duration via the communication interface,
determine a necessary distance in time between two consecutive measurements depending on the desired sampling frequency and the desired measurement duration, and
sample a measurement signal of the sensor element depending on the necessary distance in time between two consecutive measurements.

2. The sensor device according to claim 1, wherein the processing unit is configured to determine the necessary distance in time between two consecutive measurements as a difference between a reciprocal value of the desired sampling frequency and the desired measurement duration.

3. The sensor device according to claim 1, further comprising:
a memory unit, wherein the processing unit is configured to store, in the memory unit: (i) the desired sampling frequency, received via the communication interface, and/or (ii) the desired measurement duration, received via the communication interface, and wherein the processing unit is configured to read the stored desired sampling frequency and/or the stored desired measurement duration from the memory unit.

4. A method for operating a sensor device, comprising the following steps:
a. receiving a desired sampling frequency via a communication interface of the sensor device;
b. receiving a desired measurement duration via the communication interface;
c. determining a necessary distance in time between two consecutive measurements depending on the desired sampling frequency and the desired measurement duration; and
d. sampling a measurement signal of a sensor element of the sensor device depending on the necessary distance in time between two consecutive measurements.

5. The method according to claim 4, wherein, in step c, the necessary distance in time between two consecutive measurements is determined as a difference between a reciprocal value of the desired sampling frequency and the desired measurement duration.

6. The method according to claim 4, wherein:
(i) in step a, the desired sampling frequency received via the communication interface is stored in a memory unit of the sensor device, and/or (ii) in step b, the desired measurement duration received via the communication interface is stored in the memory unit of the sensor device, and
in method step c, the desired sampling frequency and/or the desired measurement duration is read from the memory unit.
